(19) United States
(12) Patent Application Publication
(10) Pub. No.: US 2026/0048385 A1
(43) Pub. Date: Feb. 19, 2026

(54) FE-CRYSTALLINE SILICA BASED MATERIALS FOR CATALYTIC REACTIONS AND ITS PREPARATION THEREOF

(71) Applicant: Council of Scientific and Industrial Research an Indian Registered Body Incorporated under the Regn., New Delhi (IN)

(72) Inventors: Chathakudath Prabhakaran VINOD, Pune (IN); Anuradha Vijay JAGTAP, Pune (IN)

(21) Appl. No.: 19/126,524

(22) PCT Filed: Oct. 30, 2023
(86) PCT No.: PCT/IN2023/050994

§ 371 Date: May 1, 2025

(30) Foreign Application Priority Data
Nov. 2, 2022 (IN) 202211062721

(51) Int. Cl. B01J 23/745; B01J 21/08; B01J 35/61; B01J 35/64; B01J 37/00; B01J 37/12; C01B 32/40

(52) U.S. Cl. CPC B01J 23/745; B01J 21/08; B01J 35/612; B01J 35/647; B01J 37/0072; B01J 37/12; C01B 32/40

(57) ABSTRACT

The present invention generally relates to transition metal(s) (mono and bimetallic) catalysts supported on crystalline silica. Specifically, the present invention relates to the process for production of crystalline silica from fumed/amorphous silica using non-noble or transition metal Fe at lower temperatures. The method of present invention is cost effective, eco-friendly and more industrially feasible than already known methods. It is useful in production of CO by CO₂ hydrogenation reaction with 100% selectivity.

### TECHNICAL FIELD OF THE INVENTION

The present invention relates to catalyst system for converting CO₂ to the selective production of CO and process for preparation thereof. More particularly, the present invention relates to catalysts comprising (mixed) transition metal(s) (mono and bimetallic) supported on crystalline silica and process for production of the catalysts at lower temperatures. The catalysts of present invention are useful in production of CO by CO₂ hydrogenation reaction with 100% selectivity.

### BACKGROUND OF THE INVENTION

In CO₂ reduction reactions, methane is also formed as a byproduct along with CO. But, methane is not a desired product due to several reasons, such as high production cost, and logistic issues. Due to transportation issues, methane from many oil wells on off-shore is simply flared. It is well-known that one mole of methane formation from CO₂ requires four moles of hydrogen gas, which makes the process uneconomical (CO₂+4H₂→CH₄+2H₂O). Global warming potential is 84 and 72 for methane and CO₂, respectively, and hence the former traps the heat effectively and contributes more to global warming. Thus, production of methane in CO₂ reduction should be minimized. Moreover, the concept of process for production of syn-fuels from CO₂ is given in FIG. 1.

In literature, various mono-metallic or bi-metallic catalyst systems are disclosed such as Cu/CeO₂, Cu—Fe/SiO₂, NiCe/Zr, Fe—CeO₂, etc. However, most of these known catalysts provide reactions above 500° C., which is not feasible or preferable. For the conversion of CO₂ to value-added products, the catalysts reported are noble metal based or transition metal based, with very high weight loading. Particularly, in case of Fe—silica catalyst after pretreatment forms crystalline silica (CS) whereas if instead of Fe other transition metals like Cu, Ni or Co were used for synthesis under same pretreatment condition it does not form crystalline catalyst. Crystallinity is to be retained after further bimetallic modification.

The optimized weight loading for amorphous to crystalline phase transformation is 0.5% of Fe over silica, above or below this weight loading crystalline catalyst not formed. In literature, Fe containing silica gel (ferrosilicon) after heating in N₂ accelerated the formation of cristobalite. After chemical analysis, it is clear that the N₂ atmosphere in presence of water vapor acted as a mildly oxidizing atmosphere to FeO. In Literature, it is reported for amorphous to crystalline phase transformation requires high temperature (above 1100° C.) but impurities like Na, Al, K and Fe reduced the crystallization temperature and accelerated the speed of transformation of the cristobalite phase.

Generally, in literature, it is known that the crystalline silica can be produced by calcining at a temperature of 1000-1100° C. or more, which makes this process very costly and not industrially feasible. Also, CO₂ hydrogenation to selectively make CO at temp below 500° C. using transition metal supported catalysts (non-noble) is a challenging task. In literature, single iron sites embedded in a silica matrix enable direct, nonoxidative conversion of methane exclusively to ethylene and aromatics. Isolated Fe over silica catalyst shows 48.1% conversion, with total hydrocarbon selectivity exceeding 99% at 1090° C. Catalyst synthesis adopted by this method is too tedious. First, the Fe₂SiO₄ (Fayalite) was synthesised, since the formation of fayalite is redox-sensitive, several steps were taken to maintain reducing conditions during synthesis and calcination. After this, a ball milling treatment is done followed by several other steps to obtain the final catalyst. In literature, Cu based catalyst are used for CO₂ to methanol production. Commercially used catalyst is Cu/Zn/Al₂O₃. The existing process for conversion of CO₂ to methanol suffers from the drawback of catalyst deactivation due to sintering of metal particles as high metal loaded catalyst used for reaction (50-70% Cu). Isolated single atom based catalyst can be solution for such problem.

Therefore, there is an unmet need to provide a process where crystalline silica is obtained at lower temperature than in already known methods. Also, there is a need to develop a low metal loaded transition metal catalyst is required for CO₂ hydrogenation catalytic reactions.

### OBJECTIVES OF THE INVENTION

An objective of the present invention is to provide a catalyst system comprising (mixed) transition metal(s) supported on crystalline silica.

Another objective of the present invention is to provide a catalyst system comprising (mixed) mono or bi transition metal(s) supported on crystalline silica.

Another objective of the present invention is to provide a process for preparation of a catalyst system comprising (mixed) mono or bi transition metal supported on crystalline silica.

Another objective of the present invention is to provide a process for the selective production of CO (carbon monoxide) from CO₂ (carbon dioxide) by using a catalyst system comprising mono or bi transition metal supported on crystalline silica.

Yet another objective of the present invention is to provide a catalytic system that can be used for non-oxidative conversion of methane to hydrocarbons and aromatics, in that the absence of adjacent iron sites in said catalyst system prevents catalytic oligomerization, coke deposition and subsequent deactivation.

Still another objective of the present invention is this catalytic system can be used for methanol synthesis via high pressure CO₂ hydrogenation reaction.

### SUMMARY OF THE INVENTION

The present invention generally relates to catalysts for converting CO₂ to the selective production of CO and process for the preparation thereof. More particularly, the present invention relates to catalysts comprising transition metal(s) (mono and bimetallic) supported on crystalline silica and the process for production of the catalysts at lower temperatures. The catalysts of the present invention are useful in the production of CO by CO₂ hydrogenation reaction with 100% selectivity.

In an aspect, the present invention discloses a catalyst system. The catalyst system includes one of a monometallic catalyst and a bimetallic catalyst, wherein the monometallic catalyst and the bimetallic catalyst comprise a mono-transition metal and a bi-transition metal, respectively, supported on crystalline silica, and wherein the mono-transition metal and the bi-transition metal are selected from a group consisting of Fe (iron), Cu (copper), Co (cobalt), and Ni (nickel) in an amount ranging from 0.1% to 0.5% by weight of the monometallic catalyst and 0.8 to 1 wt. % bimetallic catalyst.

In various embodiments, the amount of M1 metal or M1 and M2 metals in said monometallic catalyst and bimetallic catalyst, respectively, is in range of 0.1% to 1% by weight of the monometallic catalyst and the bimetallic catalyst.

In various embodiments, the amount of M1 metal or M1 and M2 metals in said monometallic catalyst and bimetallic catalyst, respectively, is in range of 0.5% to 0.8% by weight of the monometallic catalyst and the bimetallic catalyst.

In various embodiments, the bimetallic catalyst comprise Fe (iron) as a first metal and a second metal is selected from a group consisting of Cu (copper), Co (cobalt), and Ni (nickel).

In another aspect, the present invention discloses a process for preparation of the catalyst system including one of the monometallic catalyst and the bimetallic catalyst, including steps of:
a) dispersing fumed silica in a water to obtain a first silica solution;
b) adjusting pH of the first silica solution in a range of 9.45 to 9.5 using 0.1 M sodium hydroxide to obtain a second silica solution;
c) adding a first metal (Fe) precursor to the second silica solution by a drop wise method followed by stirring at a temperature in the range of 25 to 40° C. and maintained at a pH in the range of 9.45 to 9.5 for a time period ranging from 45 minutes to 1 hour to obtain a mixture;
d) centrifuging the mixture followed by drying to obtain the catalyst system comprising the monometallic catalyst in powder, which was then kept in an N₂ inert atmosphere at a temperature in the range of 700-800° C. for 5-7 hours to obtain calcined Fe monometal supported on modified silica support (FeCS);
e) adding a second metal precursor to the calcined Fe monometal supported on modified silica support system (FeCS) to obtain the catalyst system comprising the bimetallic catalyst.

In an embodiment of the present invention, only Fe can form crystalline structure.

In another embodiment, the process for preparation of the catalyst system helps to reduce the crystallization temperature for amorphous to crystalline phase transformation.

In certain embodiments, the process for preparation of the catalyst system further includes treating the monometallic catalyst in N₂ environment at 750° C. for a duration of 6 hours at a ramp rate of 2° C./min.

In various embodiments, the process for preparation of the catalyst system further includes calcining the bimetallic catalyst in static air at the temperature of 550° C. for a duration of 4 hours.

In yet another aspect, the present invention discloses a process for a selective production of CO from CO₂ using the catalyst system, including the step of:
a) heating the catalyst system in a reactor in presence of static air in-situ at temperature in the range of 450-550° C. for a duration of 3-5 hours;
b) cooling the catalyst system of step a) to upto temperature of around 100° C. by continuously flowing air;
c) feeding a CO₂:H₂ gas mixture at a ratio ranging between 1:1 to 1:4 into reactor containing the catalyst system of step b); and
d) reducing CO₂ at atmospheric pressure in a reverse water gas shift (RWGS) reaction at a temperature ranging between 200 to 480° C. with a constant gas hourly space velocity (GHSV) in a range of 9000 to 15000 mLg⁻¹h⁻¹ to obtain the CO.

In various embodiments, the process for selective production of CO from CO₂ is carried out in a plug-flow tubular quartz reactor.

In various embodiments, the catalytic performances for CO₂ hydrogenation for all the catalysts of different compositions were carried out with a plug flow tubular quartz reactor of 30 cm length having an inner diameter of 8 mm.

In various embodiments, the present invention provides a plug flow tubular quartz reactor of 30 cm length having an inner diameter of 8 mm. The reactor was fixed inside a carbolite vertical furnace equipped with a programmable temperature controller.

In certain embodiments, the isolated Fe based monometallic catalyst (FeCS) and its bimetallic modification (CuFeCS) (the bimetallic catalyst) are suitable and demonstrated for higher hydrocarbon and aromatic synthesis (non-oxidative coupling) reactions.

In certain embodiments, the ratio of CO₂:H₂ feed gas mixture is 1:1 to 1:4.

In specific embodiment, the catalytic reactions were performed with CO₂/H₂ feed gas mixture ratio of around 1:2.

In various embodiment, the isolated Fe catalyst (0.5FeCS) (monometallic catalyst) and its bimetallic modification (CuFeCS) (the bimetallic catalyst) can be effectively useful for CO₂ to methanol formation. Since metal loading is low (0.2-0.8 wt %), the deactivation because of sintering can be avoided.

These and other features, aspects, and advantages of the present subject matter will be better understood with reference to the following description and appended claims. This summary is provided to introduce a selection of concepts in a simplified form. This summary is not intended to identify key features or essential features of the claimed subject matter, nor is it intended to be used to limit the scope of the claimed subject matter.

### BRIEF DESCRIPTION OF THE DRAWINGS

The following drawings form a part of the present specification and are included to further illustrate aspects of the present disclosure. The disclosure may be better understood by reference to the drawings in combination with the detailed description of the specific embodiments presented herein.

FIG. 1 represents a general process for a production of syn-fuels from CO₂, in accordance with an embodiment of the present disclosure.

FIG. 2 represents a ultraviolet (UV) spectrum. A band below 300 nm is characteristic of isolated Fe³⁺ ions in an octahedral symmetry at the surface of silica particles, in accordance with an embodiment of the present disclosure.

FIG. 3 represents a powder x-ray diffraction (XRD) data of various catalysts. Only 0.5FeCS catalyst shows crystalline nature, in accordance with an embodiment of the present disclosure.

FIG. 4 represents a graph of Brunauer-Emmett-Teller (BET) isotherm of silica and 0.5FeCS catalyst, in accordance with an embodiment of the present disclosure.

FIG. 5 represents ²⁹Si nuclear magnetic resonance (NMR) spectra of catalyst of Silica and 0.5FeCS catalyst, in accordance with an embodiment of the present disclosure.

FIG. 6 represents a graph of raman analysis of 0.5 FeCS catalyst, in accordance with an embodiment of the present disclosure.

FIG. 7 represents transmission electron microscopy (TEM) images of different weight loaded FeCS catalyst, (a) 0.1FeCS, (b) 0.5FeCS, and (c) 1FeCS, in accordance with an embodiment of the present disclosure.

FIG. 8 represents high resolution transmission electron microscopy (HRTEM)-elemental mapping of 0.5FeCS catalyst, in accordance with an embodiment of the present disclosure.

FIG. 9 represents a graph of temperature dependent activity of 0.5FeCS catalyst with different weight loading, in accordance with an embodiment of the present disclosure.

FIG. 10 represents a graph of CO₂ conversion comparison between 0.5FeCS and 0.1Cu0.5FeCS catalysts, in accordance with an embodiment of the present disclosure.

FIG. 11 represents a graph of CO₂ conversion and CO selectivity. Temp −200 to 480° C. of 0.1Cu0.5FeCS catalyst with different CO₂:H₂ ratio 1:2 and 1:4, in accordance with an embodiment of the present disclosure.

FIG. 12 represents a graph of time on stream data of 0.5FeCS, 0.1Cu0.5FeCS and 0.1Ni0.5FeCS catalyst, wherein temperature −400° C., and CO₂:H₂=1:2, in accordance with an embodiment of the present disclosure.

FIG. 13 represents a powder XRD of catalysts of fresh and spent catalysts, in accordance with an embodiment of the present disclosure.

FIG. 14 represents a TEM image of spent 0.5FeCS catalyst, in accordance with an embodiment of the present disclosure.

FIG. 15 represents FESEM-Elemental mapping of 0.1Cu0.5FeCS catalyst A) as synthesized and B) spent catalyst, in accordance with an embodiment of the present disclosure.

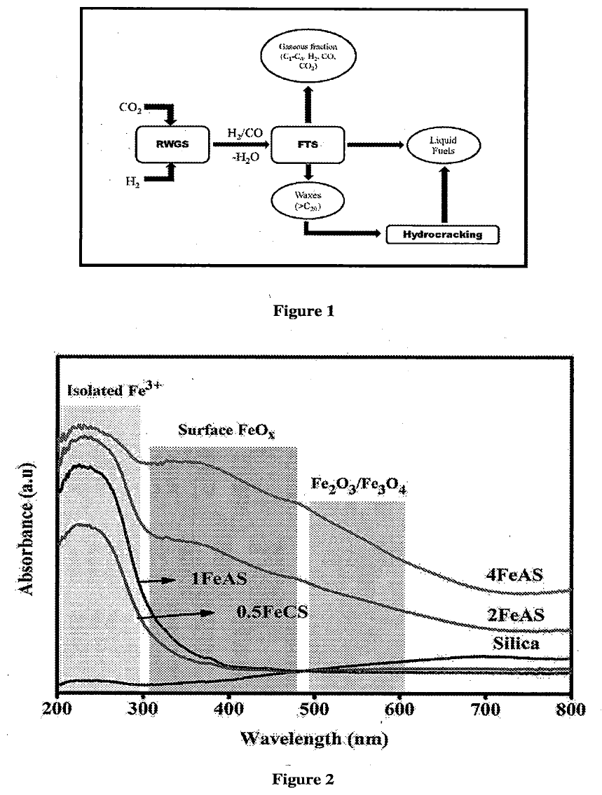

### DETAILED DESCRIPTION OF THE INVENTION

The following is a detailed description of embodiments of the disclosure. The embodiments are in such detail as to clearly communicate the disclosure. However, the amount of detail offered is not intended to limit the anticipated variations of embodiments; on the contrary, the intention is to cover all modifications, equivalents, and alternatives falling within the spirit and scope of the present disclosure as defined by the appended claims. Those skilled in the art will be aware that the present disclosure is subject to variations and modifications other than those specifically described. It is to be understood that the present disclosure includes all such variations and modifications

### Definitions

For convenience, before further description of the present disclosure, certain terms employed in the specification, and examples are delineated here. These definitions should be read in the light of the remainder of the disclosure and understood as by a person of skill in the art. The terms used herein have the meanings recognized and known to those of skill in the art, however, for convenience and completeness, particular terms and their meanings are set forth below.

The articles “a”, “an” and “the” are used to refer to one or to more than one (i.e., to at least one) of the grammatical object of the article.

The terms “comprise” and “comprising” are used in the inclusive, open sense, meaning that additional elements may be included. It is not intended to be construed as “consists of only”.

Throughout this specification, unless the context requires otherwise the word “comprise”, and variations such as “comprises” and “comprising”, will be understood to imply the inclusion of a stated element or step or group of element or steps but not the exclusion of any other element or step or group of element or steps.

The term “including” is used to mean “including but not limited to”. “Including” and “including but not limited to” are used interchangeably.

The present invention generally relates to catalysts for converting CO₂ to the selective production of CO and process for the preparation thereof. More particularly, the present invention relates to catalysts comprising transition metal(s) (mono and bimetallic) supported on crystalline silica and the process for production of the catalysts at lower temperatures. The catalysts of the present invention are useful in the production of CO by CO₂ hydrogenation reaction with 100% selectivity.

The present invention provides a process for production of said crystalline silica from fumed/amorphous silica using non-noble or transition metal Fe at lower temperatures, and this process is termed as “pre-treatment step” in said CO production process. Accordingly, the method of invention is cost effective, eco-friendly and more industrially feasible than already known methods.

The existing synthesis methods to obtain conventional transition metal based catalysts, involve harsh chemical treatment, ball milling treatment, followed by several other steps. Compared to these methods, a very simple method for the synthesis of monometallic FeCS and bimetallic CuFeCS catalysts with isolated Fe sites is provided in the present disclosure. In the whole synthesis, only water is used as solvent and no hazardous chemicals like toluene or HNO₃ are employed.

The terms “monometallic catalyst” or “FeCS catalyst” or “0.5FeCS catalyst” are used herein interchangeably with same meaning throughout the specification.

The terms “bimetallic catalyst” or “CuFeCS catalyst” or “0.1Cu0.5FeCS catalyst” are used herein interchangeably with same meaning throughout the specification.

Ratios, concentrations, amounts, and other numerical data may be presented herein in a range format. It is to be understood that such range format is used merely for convenience and brevity and should be interpreted flexibly to include not only the numerical values explicitly recited as the limits of the range, but also to include all the individual numerical values or sub-ranges encompassed within that range as if each numerical value and sub-range is explicitly recited. For example, 0.1 to 1% should be interpreted to include not only the explicitly recited limits of 0.3 to 1% but also to include sub-ranges, such as 0.5 to 0.92%, 0.61 to 0.99%, 0.99 to 1%, and so forth, as well as individual amounts, including fractional amounts, within the specified ranges, such as 0.356%, 0.112%, and so on.

Unless defined otherwise, all technical and scientific terms used herein have the same meaning as commonly understood by one of ordinary skill in the art to which this disclosure belongs. Although any methods and materials similar or equivalent to those described herein can be used in the practice or testing of the disclosure, the preferred methods, and materials are now described. All publications mentioned herein are incorporated herein by reference.

In an embodiment, the present invention discloses a catalyst system. The catalyst system includes one of a monometallic catalyst and a bimetallic catalyst, wherein the monometallic catalyst and the bimetallic catalyst comprise a mono-transition metal and a bi-transition metal, respectively, supported on crystalline silica, and wherein the mono-transition metal and the bi-transition metal are selected from a group consisting of Fe (iron), Cu (copper), Co (cobalt), and Ni (nickel) in an amount ranging from 0.5% to 0.8% by weight of the monometallic catalyst and the bimetallic catalyst.

In various embodiments, the bimetallic catalyst comprise Fe (iron) as a first metal and a second metal is selected from a group consisting of Cu (copper), Co (cobalt), and Ni (nickel). In an embodiment, a surface area of the catalyst system ranges from 4 to 8 m²/g.

In another embodiment, a pore radius of the catalyst system ranges from 10 to 18 Å.

In another embodiment, M1 is Fe, and loading of Fe in said catalyst system is 0.1 to 0.6 wt. % or 0.5 wt. %.

In another embodiment, M2 is selected from Cu (copper), Co (cobalt), and Ni (nickel), and loading of M2 metal ranges from 0.1-0.5 wt. %.

In another aspect, the present invention discloses a process for preparation of the catalyst system including one of the monometallic catalyst and the bimetallic catalyst, including steps of:
a) dispersing 500 mg of fumed silica in a 50 mL Millipore water to obtain a first silica solution;
b) adjusting pH of the first silica solution in a range of 9.45 to 9.5 using 0.1 M sodium hydroxide to obtain a second silica solution;
c) adding a first metal (M1; Fe) precursor to the second silica solution by a drop wise method followed by stirring at a temperature in a range of 25 to 40° C. and maintained at pH in a range of 9.45 to 9.5 for a time period in a range of 45 minutes to 1 hour to obtain a mixture;
d) centrifuging the mixture in 8000 to 12000 rpm for 6 to 12 min followed by drying to obtain the catalyst system comprising the monometallic catalyst; and then obtained powder was treated in an N₂ atmosphere at 750° C. for 6 h, and labeled as FeCS.
e) adding a second metal (M2) precursor to the catalyst system comprising the monometallic catalyst to obtain the catalyst system comprising the bimetallic catalyst.

In certain embodiments, the first metal precursor is selected from a group consisting of Fe (iron), Cu (copper), Co (cobalt), and Ni (nickel) in an amount ranges from 0.1% to 0.5% by weight of the monometallic catalyst.

In certain embodiments, the centrifuging of the mixture is carried out at 8000-12000 RPM for a duration of 6-12 min.

In certain embodiments, the centrifugation step is carried out at least one time, at least two times or at least three times.

In various embodiment, the second metal precursor is selected from a group consisting of Cu (copper), Co (cobalt), and Ni (nickel) in an amount ranges from 0.1% to 0.5% by weight of the monometallic catalyst.

In such embodiment, in case of the bimetallic catalyst, the first metal precursor is Fe (iron).

In an embodiment of the present invention, only Fe can form crystalline structure.

In another embodiment, the process for preparation of the catalyst system helps to reduce the crystallization temperature.

In certain embodiments, the process for preparation of the catalyst system further includes treating the monometallic catalyst in N₂ environment at 750° C. for a duration of 6 hours at a ramp rate of 2° C./min.

In various embodiments, the process for preparation of the catalyst system further includes calcining the bimetallic catalyst in static air at the temperature of 550° C. for a duration of 4 hours.

In an exemplary embodiment, the process for the preparation of the monometallic catalyst (0.5 FeCS) including the steps of:
a) dispersing fumed silica in the water to obtain the silica solution;
b) adjusting pH of the silica solution in a range of 9.45 to 9.5 using 0.1M NaOH;
c) adding dropwise the first metal precursor (Fe) to the silica solution having pH in a range of 9.5 to 9 and stirring the silica solution for a duration of 45 minutes to 1 hour to obtain a mixture;
d) centrifuging and drying the mixture to obtain the monometallic catalyst including mono transition metal supported on fumed silica; and
e) treating the monometallic catalyst in N₂ environment at 750° C. for a period of 6 h at the ramp rate of 2° C./min.

In another exemplary embodiment, the process for the preparation of the bimetallic catalyst including the steps of:
a) dispersing the monometallic catalyst (0.5 FeCS) in a water to obtain a homogeneously mixed solution;
b) adjusting the pH of the homogeneously mixed solution in a range of 9.45 to 9.5 using sodium hydroxide (0.1M NaOH);
c) adding dropwise the second metal precursor (Cu) to the homogeneously mixed solution having pH in a range of 9.45 to 9.5 and stirring the solution for a time period in a range of 45 minutes to 1 hour to obtain a mixture;
d) centrifuging and drying the mixture to obtain the bimetallic catalyst (0.1Cu0.5FeCS); and
e) calcining the bimetallic catalyst in static air at the temperature of 550° C. for a duration of 4 hours.

In another embodiment, the first metal precursor and the second metal precursor are selected from Iron (III) nitrate nonahydrate (Fe(NO₃)₃·(H₂O)₉) as Fe precursor, Copper (II) nitrate trihydrate (Cu(NO₃)₂·3H₂O) as Cu precursor and Nickel (II) nitrate hexahydrate (Ni(NO₃)₂·6H₂O) as Ni precursor.

In one embodiment, the amorphous silica is treated with Fe metal and calcined at a temperature of lower than 750° C. for 6 hours to obtain the crystalline silica.

In certain embodiments, in case of the bimetallic catalyst, composition of the catalyst includes modified silica supported bimetallic catalyst. Both metals belong to transition metal family (Mn, Fe, Co, Cu, or Ni).

In yet another aspect, the present invention discloses a process for a selective production of CO from CO₂ using the catalyst system, including the step of:
a) heating one of the monometallic catalyst and the bimetallic catalyst in presence of static air in-situ at 500° C. for a duration of 4 hours;
b) cooling the one of the monometallic catalyst and the bimetallic catalyst to 100° C. by continuously flowing air;
c) feeding a CO₂:H₂ gas mixture at a ratio ranging between 1:1 and 1:4; and
d) reducing CO₂ at atmospheric pressure in a reverse water gas shift (RWGS) reaction at a temperature ranging between 200 to 480° C. with a constant gas hourly space velocity (GHSV) in a range of 9000 to 15000 mLg⁻¹h⁻¹ to obtain the CO.

In various embodiments, the process for selective production of CO from CO₂ is carried out into a plug-flow tubular quartz reactor. As used herein the term “plug-flow tubular quartz reactor” refers to a type of reactor commonly used in chemical and industrial processes for carrying out continuous-flow reactions. It consists of a tubular vessel made of quartz, which is resistant to high temperatures and corrosive chemicals. The plug-flow tubular quartz reactor offer advantages such as high conversion rates, precise control of reaction conditions, and scalability for large-scale production.

In one embodiment, preferably the ratio of CO₂:H₂ gas mixture is 1:2.

In certain embodiments, the isolated Fe based monometallic catalyst (FeCS) and its bimetallic modification (CuFeCS) (the bimetallic catalyst) are suitable and demonstrated for higher hydrocarbon and aromatic synthesis (non-oxidative coupling) reactions.

In various embodiment, the isolated Fe catalyst (0.5FeCS) (monometallic catalyst) and its bimetallic modification (CuFeCS) (the bimetallic catalyst) can be effectively useful for CO₂ to methanol formation. Since metal loading is low (0.2-0.8 wt %), the deactivation because of sintering is avoided.

In certain embodiments, for CO₂ to CO hydrogenation 0.1Cu0.5FeCS (FeCu Supported over crystalline silica) shows highest CO₂ conversion 27% and 100% CO selectivity, whereas 0.1Ni0.5FeCS (FeNi Supported over crystalline silica) shows less conversion 22% and 95% CO selectivity at 400° C. where CO₂:H₂ ratio is 1:2. (FIG. 12).

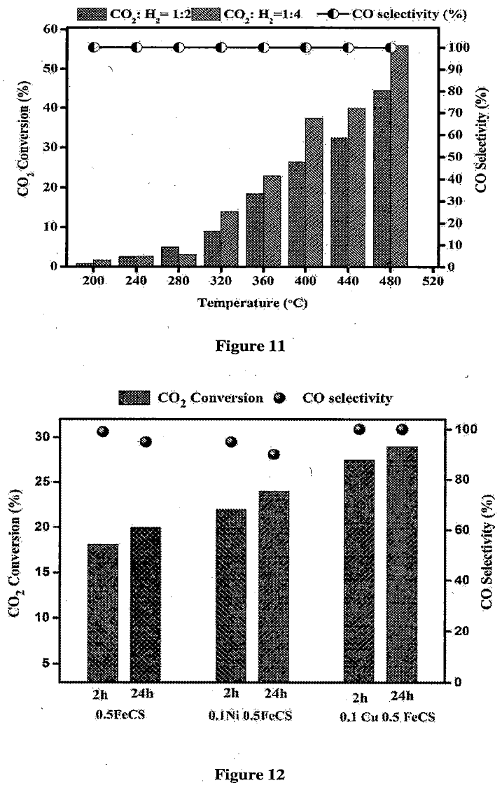

In various embodiments, further increments in CO₂ conversion are observed (27% to 37%) when CO₂ to H₂ ratio changes from 1:2 to 1:4 for CuFeCS catalyst (FIG. 11)

In another embodiment, the crystalline silica is used as support for the monometallic catalyst or the bimetallic catalyst systems for CO production from CO₂.

In another embodiment, the lower loading amount of the precursor metals is sufficient to obtain 100% selectivity for CO. The precursor metal(s) are well dispersed on the surface of the crystalline silica support when metal loading is lesser, and at higher loading, it may agglomerate or provide precursor metals as a mixture of elemental metals, metal oxides and metal nanoparticles.

In another embodiment, characteristic absorption bands for isolated Fe³⁺ species over surface sites are observed in the UV-vis spectra of low loading FeAS (iron amorphous silica) and FeCS samples. The isolated Fe³⁺ in an octahedral symmetry species having a band below 300 nm. Surface FeOx species show a band between 200 and 500 nm whereas above 500 nm characteristic band for Fe nanoparticles. UV-vis spectra of silica have no peak in the 200-500 regions. For 0.5FeCS catalyst displayed a band below 300 nm ascribed to isolated Fe³⁺ species, this band present in all catalysts, as Fe loading increase peak corresponds to FeOx and Fe nanoparticles are detected. 2FeAS and 4FeAS catalysts show a broad band between 350 and 400 nm that could be assigned either to iron oxide or to surface FeOx species and around 500 nm indicates presence of Fe₂O₃ or Fe₃O₄ type species (FIG. 2).

In yet another embodiment, at post-pretreatment the crystalline silica has lower surface area and pore radius than amorphous silica. In such embodiment, the surface area for fumed silica is 324.77 m²/g and after pre-treatment it decreased to 5.22 m²/g for crystalline silica. The pore Radius Dv(r) is 59.052 Å and after pre-treatment it decreased to 16.880 Å for crystalline silica (FIG. 4).

According to the present invention, the crystalline silica catalyst (catalyst system as disclosed by the present invention) used in production of CO by CO₂ hydrogenation reaction, wherein the hydrogenation reaction is described by the following chemical reaction:

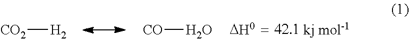

In certain embodiments, the monometallic catalyst and bimetallic catalyst (heterogeneous catalysts) are highly active for reverse water gas shift reaction below 500° C. and its bimetallic modifications are active for other catalysis applications.

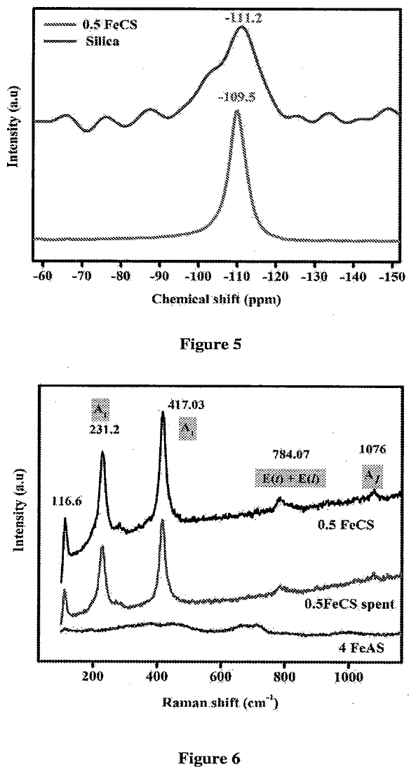

In another embodiment, the monometallic catalyst shows 1/5 relaxation delay (T₁) as 20 sec in ²⁹Si NMR spectra of the monometallic catalyst whereas the fumed silica shows T₁ as 1000 sec (FIG. 5).

In another embodiment, FIG. 6 shows the Raman analysis of the monometallic catalyst and the spent monometallic catalyst. The Raman line at 784.5 cm⁻¹ was assigned to a degenerate TO-LO pair, E (t)+E(1) Transverse (TO) and longitudinal (LO) optical modes as well as surface optical modes, occurring between the TO and LO modes.

In another embodiment, very high space-time yield in CO₂ hydrogenation reaction is obtained (5 times higher). As used herein the term “space-time yield” refers to a metric used to evaluate the efficiency and productivity of a chemical or industrial process. It is a measure of the amount of product generated per unit volume of reactor space and unit time. The space-time yield is calculated by dividing the volumetric flow rate of the desired product by the volume of the reactor and the reaction time. It is typically expressed in units such as kg/L/h or mol/L/s. The space-time yield takes into account both the conversion of reactants and the productivity of the reactor system. A higher space-time yield indicates a more efficient process, as it represents a greater production rate per unit reactor volume and time.

Although the subject matter has been described in considerable detail with reference to certain examples and implementations thereof, other implementations are possible.

### Examples

The disclosure will now be illustrated with following examples, which is intended to illustrate the working of disclosure and not intended to take restrictively to imply any limitations on the scope of the present disclosure. Unless defined otherwise, all technical and scientific terms used herein have the same meaning as commonly understood to one of ordinary skill in the art to which this disclosure belongs. Although methods and materials similar or equivalent to those described herein can be used in the practice of the disclosed methods and compositions, the exemplary methods, devices, and materials are described herein. It is to be understood that this disclosure is not limited to particular methods, and experimental conditions described, as such methods and conditions may apply.

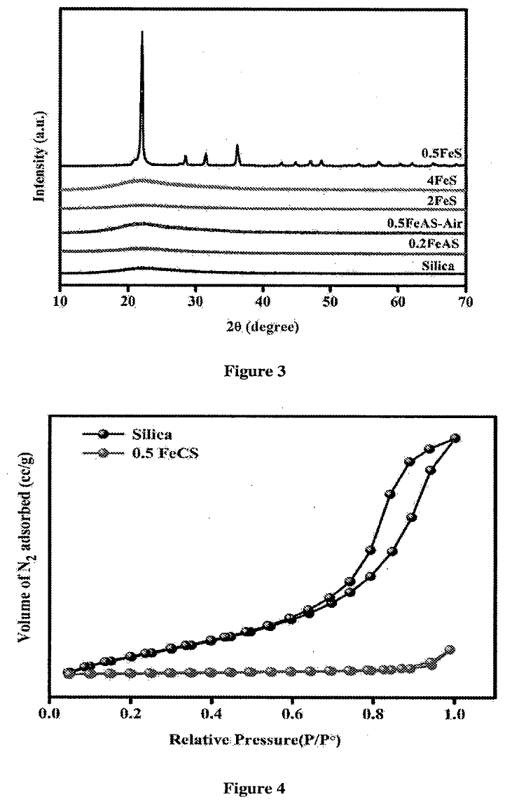

The 0.5% in weight of Fe metal only is forming crystalline structure, and XRD (FIG. 3), NMR (FIG. 5) and Raman (FIG. 6) proves phase matches with α-cristobalite so formed material is Fe mediated cristobalite.

### Example 1: Synthesis of 0.5FeCS Catalyst System Comprising Monometallic Catalyst

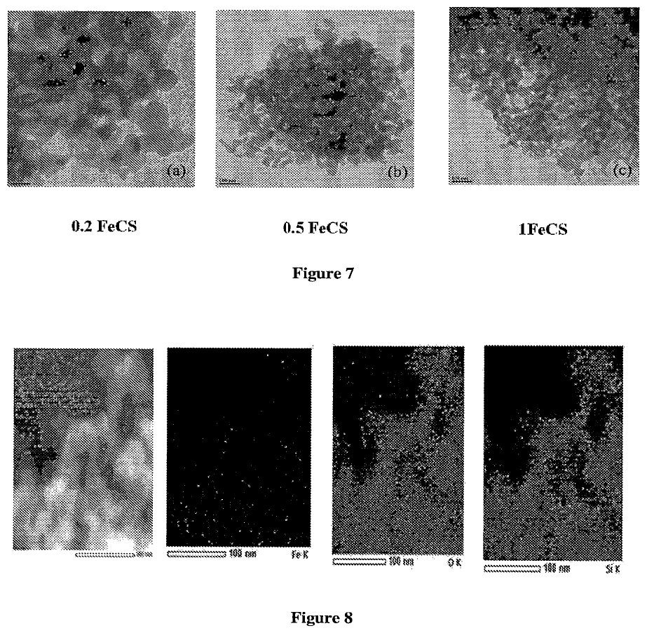

Fumed silica (500 mg) was added in 50 ml millipore water and the pH was adjusted using NaOH to 9.45-9.5. To the solution, aqueous Iron (III) nitrate nonahydrate (Fe(NO₃)₃(H₂O)₉) (Fe precursor) solution was added by drop wise method maintaining the same pH throughout the addition. The solution was stirred for another 1 hour at same pH to obtain a mixture. The pale yellow powder sample of catalyst system comprising the monometallic catalyst was obtained after centrifugation and drying of the mixture. The catalyst system obtained was pre-treated in N₂ environment at 750° C. for 6 hours at the ramp rate of 2° C./min to get white coloured calcined Fe monometal supported on modified silica support (FeCS) catalyst. FIG. 3 shows a graph of powder XRD data. Only FeCS catalyst showed crystalline nature. FIG. 4 shows a graph of BET Isotherm. The catalyst of the present invention showed surface area of 5.224 m²/g and pore radius Dv (r)=16.880 Å. FIG. 7 shows TEM images of different catalysts (a) 0.1FeCS, (b) 0.5FeCS, and (c) 1FeCS. FIG. 8 shows HRTEM-Elemental mapping of catalyst.

### Example 2: Synthesis of 0.1Cu0.5FeCS Catalyst System Comprising Bimetallic Catalyst

0.5FeCS (500 mg) catalyst obtained in Example 1 was dispersed in 50 ml of millipore water and pH was adjusted to 9.45-9.5 using 0.1 M NaOH solution. To this solution, Copper (II) nitrate trihydrate (Cu(NO₃)₂·3H₂O) (copper precursor) at same pH was added. The solution was stirred for another 1 hour at same pH. After centrifugation and drying the catalyst at 80° C. for overnight, the light blue coloured catalyst was obtained. The light blue coloured catalyst was calcined in static air at 550° C. for 4 hour to obtain the catalyst system comprising bimetallic catalyst 0.1Cu0.5FeCS.

### Example 3: Preparation of CO from CO₂ Using Said Catalyst Including Essential Pre-Treatment Steps

All catalytic tests were carried out in a plug-flow tubular quartz reactor of 30 cm length and an inner diameter of 8 mm. The reactor was fixed inside a carbolite vertical furnace equipped with a programmable temperature controller.

Typically, 100 mg powder monometallic catalyst or the bimetallic catalyst was loaded into the reactor. Prior to CO₂ hydrogenation, catalyst were heated in presence of static air in situ at 500° C. for 4 hour. The catalysts were then cooled to 100° C. by continuously flowing air. The flow rate of feed gases was 15 ml/min with a GHSV of 9000 mLg⁻¹h⁻¹, and controlled by individual Alicat mass flow controllers. CO₂ and H₂ were passed through the reactor with a ratio of 1:2. Catalytic bed temperature was increased to reaction temperature. To prevent possible condensation of product the pipeline from the catalyst bed to the gas chromatograph was heated at 120° C. Obtained products were detected by an online Nucon GC (gas chromatograph) 5765, attached with methanizer and flame ionization detector (FID). The effluent gas from the reactor was analyzed by using an online gas chromatograph (Nucon 5765, GC) equipped with two columns in parallel: one was a HP plot-Q capillary column connected to a FID for the analysis of hydrocarbons and the other a DB624 capillary column connected to a flame ionization detector (FID) for the analysis of gases CO, CO₂ and CH₄. The stability tests were performed under the same space velocity at 673 K for 24 hour.

The conversion of CO₂ (X_{CO2}) was calculated using equation-2

$${Xco}_{2} ( \% ) = \frac{[ {CO}_{2} ] in - [ {CO}_{2} ] out}{[ {CO}_{2} ] in} \qquad 2$$

Where [CO₂]ᵢₙ and [CO₂]ₒᵤₜ is the concentration of CO₂ in the inlet and outlet gas, respectively.

The selectivity of a specific product (S specific product) was calculated using equation-3

$${S}_{specific product} = \frac{\% specific product}{\% total products} \times 100 \qquad 3$$

Where % specific product was calculated from standard calibration

The Space time yield was calculated by equation-4

$$S T Y ( μmol \cdot {g}_{cat .}^{- 1} {sec}^{- 1} ) = \frac{{Sel}_{CO} \times {X}_{[ CO 2 ]} \times {[ {CO}_{2} ]}_{total}}{{m}_{c atalyst}} \qquad 4$$

where X_{CO2} is the conversion of CO₂, [CO₂] total is the total concentration of CO₂ (mol/sec), and m_{catalyst} is the mass of the catalyst

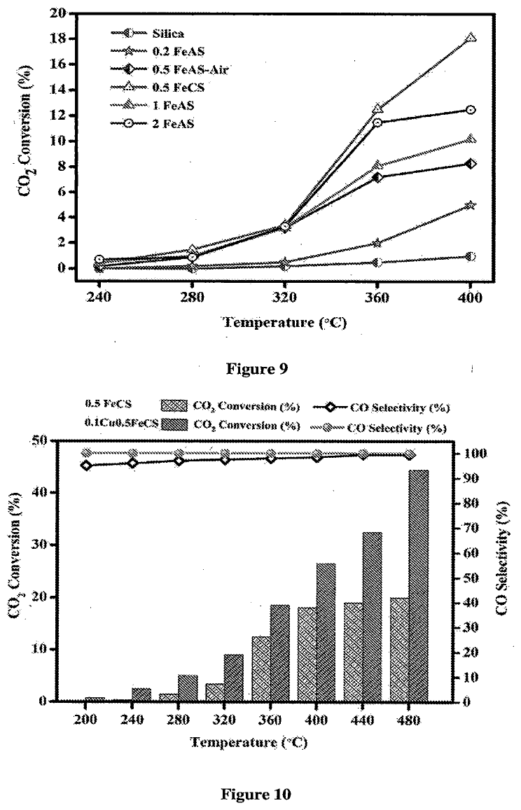

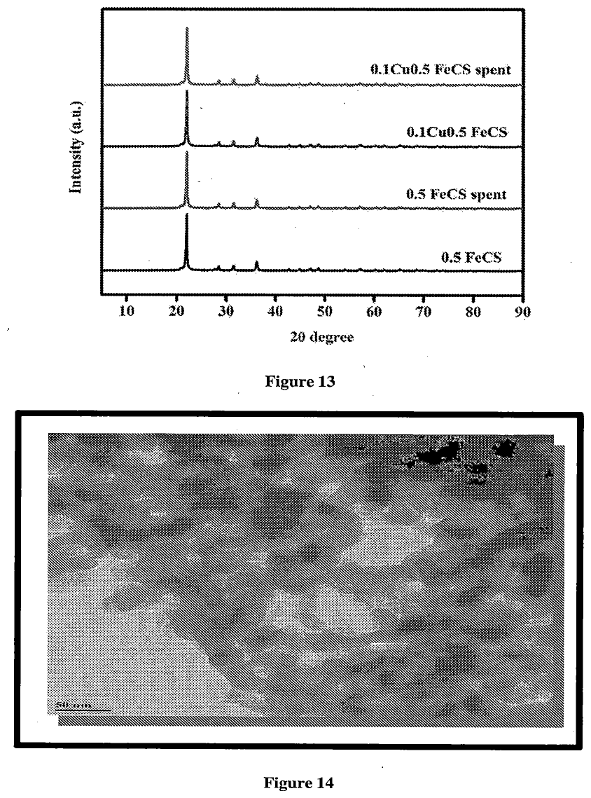

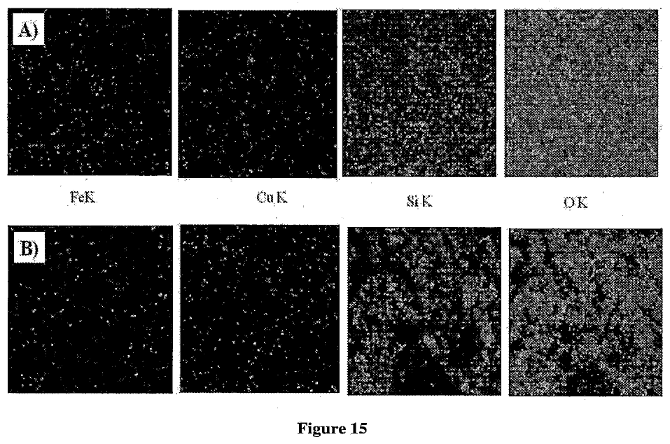

FIG. 9 shows the temperature dependent activity at temperature range 200-400° C. of catalyst with different wt. % of Fe loaded catalyst and The comparison of the conversion revels that 0.5FeCS showed highest CO₂ conversion (18.3%) than different weight (Fe) loaded catalysts. To check effect of support the reaction over N₂ treated fumed silica under similar condition were also carried out and silica showed 1% conversion. Importance of pretreatment in N₂ also reflected in activity as air treated 0.5FeAS catalyst showed 8.3% conversion and N₂ treated sample (0.5FeCS) showed 2 times higher conversion than air treated sample. FIG. 10 depicts comparison between 0.5FeCS and 0.1Cu0.5FeCS catalyst. After adding 0.1 wt. % of Cu provided considerable enhancement in activity. At 480° C., 0.5FeCS showed 20% conversion and 0.1CuFeCS showed 45% CO₂ conversion. FIG. 11 shows a graph of CO₂ conversion and CO selectivity. Temp-200 to 480° C. of 0.1Cu0.5FeCS Catalyst with different CO₂:H₂ ratio 1:2 and 1:4. On increasing the CO₂ to H₂ ratio from 1:2 to 1:4 enhancement in CO₂ conversion was observed. FIG. 12 shows a graph of time on stream data of 0.5FeCS, 0.1Ni0.5FeCS and 0.1Cu0.5FeCS catalyst. Temp.−400° C., and CO₂:H₂=1:2. The long-term time on stream stability of the 0.5FeCS, 0.1Ni0.5FeCS and 0.1Cu0.5FeCS catalysts was analyzed at 400° C. for 24 h (CO₂/H₂=1:2) catalyst showed excellent stability without deactivation even after 24 h of reaction, with time CO₂ conversion increased due to conditioning of the active metal in the reaction mixture i.e., metal got reduced during the reaction. In case of 0.5FeCS, 0.1Ni0.5FeCS CO selectivity decreased with time but 0.1Cu0.5FeCS catalyst showed constant CO selectivity. FIG. 13 shows a graph of powder XRD of catalysts of fresh and spent catalysts. Spent catalyst XRD spectra reveal the crystallinity retained after reaction. FIG. 14 shows a graph of TEM image of spent 0.5FeCS catalyst. TEM image of spent catalyst indicated catalyst was highly stable in reaction condition as no structure deformation were observed in spent catalyst. FIG. 15 shows FESEM-elemental mapping of 0.1Cu0.5FeCS catalyst A) as synthesized B) spent catalyst. FESEM elemental mapping also supported to TEM analysis as no agglomeration were observed in spent catalyst indicates thermally stability of catalyst.

The comparative data of selective CO₂ hydrogenation to CO using the catalyst system of present invention with other catalyst is given below in table 1.

TABLE 1

| | | Metal | | | | | | |
|---|---|---|---|---|---|---|---|---|
| Sr. | | loading | | Temp. | CO₂ | CO | STY | |
| No. | Catalyst | (wt %) | CO₂:H₂ | (° C.) | Conversion | Selectivity | (μmol · g⁻¹_{cat} · S⁻¹) | Ref. |
| 1. | 0.5FeCS | 0.5 | 1:4 | 400 | 25 | 90.0 | 9.2 | This Work |
| 2. | 0.1Cu0.5FeCS | 0.6 | 1:4 | 400/480 | 37/56 | 100/100 | 13.7/20.8 | This Work |
| 3. | Ni/TiO₂ | 5.20 | 1:4 | 360 | 5.8 | 99.0 | 2.1 | ACS Catal. 2019, 9, 6342- |
| | | | | | | | | 6348 |
| 4. | Ni₃—Fe₉/ZrO₂ | 40 | 1:2 | 400 | 18.0 | 96.0 | 6.4 | J. Catal. 2019, 374, 60-71 |
| 5. | Ni/SiO₂ | 15 | 1:4 | 400 | 15.0 | 97.0 | 4.9 | J. Am. Chem. Soc. 2021, |
| | | | | | | | | 143, 11, 4268-4280 |
| 6. | Co/ZrO₂ | 10 atom | 1:4 | 340 | 9.8 | 97.0 | 2.0 | ACS Catal. 2021, 11, 15, |
| | | % | | | | | | 9450-9461 |
| 7. | KCuAlFe | 12.8 | 1:1 | 350 | 10.0 | 99.0 | 3.9 | ACS Catal. 2021, 11, 20, |
| | | | | | | | | 12609-12619 |
| 8. | Pt—Fe₂O₃ | 0.02 | 1:3 | 500 | 35 | 99.5 | 13 | ACS Catal. 2021, 11, 23, |
| | | | | | | | | 14586-14595 |
| 9. | Fe—Cu/ | 50 | 1:4 | 400 | 43.0 | 99.9 | — | ACS Sustainable Chem. |
| | CeO₂—Al₂O₃ | | | | | | | Eng. 2021, 9, 36, 12155- |
| | | | | | | | | 12166 |

In table 1, CO₂: carbon dioxide; CO: carbon monoxide; H₂: hydrogen; STY: space time yield.

A skilled artisan will appreciate that the quantity and each of the ingredients can be used in different combinations or singly. All such variations and combinations would be falling within the scope of present disclosure. The foregoing examples are merely illustrative and are not to be taken as limitations upon the scope of the invention. Various changes and modifications to the disclosed embodiments will be apparent to those skilled in the art. Such changes and modifications may be made without departing from the scope of the invention.

### Advantages of the Present Invention

The process for the production of the crystalline silica catalyst is cost effective, eco-friendly and more industrially feasible than already known processes.

The low metal loaded crystalline silica catalyst produced shows 100% selectivity towards CO in CO₂ hydrogenation reaction.

The low metal loaded crystalline silica catalyst produced has very high space-time yield in CO₂ hydrogenation reaction (5 times higher).

The catalyst system supported on crystalline silica offers excellent stability and longevity. This ensures prolonged catalyst lifetime, reducing the need for frequent catalyst replacement and improving the overall economics of the catalytic process.

The catalyst system is easy to prepare, and without the need of any structural auxiliary agent, a bonding agent, and/or a pore-forming agent.

The catalyst system provides preparation of syn gas from CO₂ hydrogenation at atmospheric pressure conditions and temperature below 500° C.

While the preparation of catalyst system, the step of pretreatment in the N₂ environment plays an important role in amorphous to crystalline phase transformation of silica, which is very easy to perform and synthesis is completed in 3 h, also no aging is required.

The preparation of catalyst system of present invention is greener as in the whole synthesis, only water is used as a solvent, and no hazardous chemicals like tertiary amines, amino alcohol, amino acid, polyhydric alcohol, or quaternary ammonium base are used.

Specifically, the present invention covers the deposition precipitation method for the synthesis of crystalline catalysts and the temperature is 750° C. which is comparatively lower than the literature known method (which are around 900-1100° C.).

The catalyst provided herein is useful in selective production of CO at atmospheric pressure conditions and moderate temperatures.

The invention finds applicability in various catalytic reactions including but not limited to hydrogenation, oxidation, and other transformation processes. The catalyst system's versatility and performance make it suitable for diverse industrial applications, such as petrochemical, pharmaceutical, and fine chemical industries.

1-12. (canceled)

13. A catalyst system comprising:
a monometallic catalyst or a bimetallic catalyst, and
a support;
wherein the monometallic catalyst comprises M1 as metal, and the bimetallic catalyst comprises M1 and M2 as metals, wherein said metal of monometallic catalyst and said metals of bimetallic catalyst is/are selected from transition metal;
wherein an amount of M1 method or M1 and M2 metals in said monometallic catalyst and bimetallic catalyst, respectively, is in range of 0.1% to 1% by weight of the monometallic catalyst and the bimetallic catalyst;
wherein said M1 metal is iron; and
wherein said support is a crystalline silica support.

14. The catalyst system as claimed in claim 13, wherein an amount of M1 metal or M1 and M2 metals in said monometallic catalyst and bimetallic catalyst, respectively, is in range of 0.5% to 0.8% by weight of the monometallic catalyst and the bimetallic catalyst.

15. The catalyst system as claimed in claim 13, wherein the M2 metal is selected from a group consisting of Cu (copper), Co (cobalt), and Ni (nickel).

16. The catalyst system as claimed in claim 13, wherein the catalyst system has a surface area in a range of 4 to 8 m²/g; and the catalyst system has a pore radius in the range of 10 to 18 Å.

17. A process for preparation of the catalyst system as claimed in claim 13, comprising steps of:
a) dispersing fumed silica in a water to obtain a first silica solution;
b) adjusting pH of the first silica solution in a range of 9.45 to 9.5 using 0.1 M sodium hydroxide to obtain a second silica solution;
c) adding a first metal (M1; Fe) precursor to the second silica solution by a drop wise method followed by stirring at a temperature in a range of 25 to 40° C. and maintained at a pH in a range of 9.45 to 9.5 for a time period in a range of 45 minutes to 1 hour to obtain a mixture;
d) centrifuging the mixture followed by drying to obtain the catalyst system comprising the monometallic catalyst in powder, which was then kept in an N₂ inert atmosphere at a temperature in the range of 700-800° C. for 5-7 hours to obtain a calcined Fe monometal supported on modified silica support (FeCS); and
e) adding a second metal (M2) precursor to the calcined Fe monometal supported on modified silica support (FeCS) to obtain the catalyst system comprising the bimetallic catalyst.

18. The process as claimed in claim 17, wherein the first (M1) metal precursor is Iron (III) nitrate nonahydrate; and wherein the second metal (M2) precursor is selected from Copper (II) nitrate trihydrate, Iron (III) nitrate nonahydrate [Fe(NO₃)₃(H₂O),], Copper (II) nitrate trihydrate (Cu(NO₃)₂·3H₂O), and Nickel (II) nitrate hexahydrate (Ni(NO₃)₂·6H₂O) as Ni precursor.

19. The process as claimed in claim 17, wherein the step d) further comprises treating the monometallic catalyst in N₂ environment at 750° C. for a duration of 6 hours at a ramp rate of 2° C./min.

20. The process as claimed in claim 17, wherein the step e) further comprises calcining the bimetallic catalyst in static air at a temperature of 550° C. for a duration of 4 hours.

21. A process for a selective production of CO from CO₂, comprising the steps of:
a) heating the catalyst system as claimed in claim 1 in presence of static air in-situ in a reactor at a temperature in a range of 400 to 600° C. for a time period in a range of 2 to 6 h to obtain a reaction mixture;
b) cooling the reaction mixture of step a) to a temperature of about 100° C. by continuously flowing an air;
c) feeding a CO₂:H₂ gas mixture at a ratio in a range of 1:1 to 1:4 into the reactor containing reaction mixture of step b); and
d) reducing CO₂ at atmospheric pressure in a reverse water gas shift (RWGS) reaction at a temperature in a range of 200 to 480° C. with a constant gas hourly space velocity (GHSV) in a range of 9000 to 15000 mLg⁻¹h⁻¹ to obtain the CO.

22. The process as claimed in claim 21 wherein the reactor is a plug-flow tubular quartz reactor.

23. The process as claimed in claim 21, wherein the ratio of CO₂:H₂ feed gas mixture is in a range of 1:1 to 1:4.
